(19) United States
(12) Patent Application Publication
(10) Pub. No.: US 2004/0201118 A1
(43) Pub. Date: Oct. 14, 2004

(54) Method and apparatus for casting a concrete product

(76) Inventors: Lassi Jarvinen, Valkeakoski (FI); Aimo Seppanen, Saaksmaki (FI)

Correspondence Address: BURNS DOANE SWECKER & MATHIS L L P, POST OFFICE BOX 1404, ALEXANDRIA, VA, 22313-1404, US

(21) Appl. No.: 10/485,767

(22) PCT Filed: Aug. 29, 2003
(86) PCT No.: PCT/FI03/00635

(30) Foreign Application Priority Data
Sep. 2, 2002 (FI) 20021561

(51) Int. Cl. B29C 39/06

(52) U.S. Cl. 264/33; 425/208; 425/209; 425/456

(57) ABSTRACT

A method and apparatus are disclosed for casting hollow-core concrete products, in which method concrete mix is fed into a mold of a delimited cross section traveling on a casting bed. According to the invention, the concrete mix is compacted with the help of vibratory shoes operating downstream of the concrete mix feed means, and the correct shape of the hollow-core cavities is maintained with the help of troweling mandrels.

The present invention relates to a method for making elongated concrete products by a slipform casting method. More specifically, the invention relates to the manufacture of hollow-core concrete products by a slipform casting method.

Conventional slipforming apparatuses employed today are generally based on either extruder or slipforming techniques. In extruder-type machines, concrete mix is fed from a hopper onto auger feeders that extrude the concrete mix into a mold defined by side and top troweling plates. When casting hollow-core slabs, the auger feeders are followed by core-shaping mandrels that shape the hollow-core cavities of the concrete product being cast. Compaction of the concrete product being cast is effected by means of the vibrating/troweling movement of the side and top troweling plates, while the formation of the hollow-core cavities takes place with the help of the compacting movement of the core-shaping mandrel. Propelled by the reaction forces imposed by the auger feeders, the entire casting apparatus supported on wheels moves along a casting bed. The ready-cast product remains on the casting bed.

In apparatuses based on the slipforming technique, the concrete mix is fed along with the progress of the casting operation first to the lower portion of the casting mold defined by the mold side walls moving with the casting machine and by the stationary casting bed. Subsequent to this first step of concrete mix feed, the flowing concrete meets vibratory shoes that compact the concrete cast into the mold by vibration and simultaneously initially form desired hollow-core cavities in the already cast layer of concrete. Arranged to travel immediately behind the vibratory shoes are adapted troweling mandrels that finish the shape of the hollow-core cavity formed in the cast product. Onto the trailing end of the troweling mandrels is poured concrete mix in a second feed step, wherein the top layer of the product being cast is laid and subsequently compacted by means of a vibratory troweling plate operating above the trailing end of the troweling mandrel. The ready-cast product remains on the casting bed.

Conventionally, slipform casting techniques are used in the manufacture of long products that after curing are trimmed by sawing into end products of suitable length.

The present invention combines extruder and slipforming techniques into a novel slipform casting technique. In the slipform casting method according to the invention, the concrete mix flows from a hopper onto auger feeders that propel the concrete about the vibratory shoes. The vibratory shoes compact the concrete mix by vibration and simultaneously initially form the hollow-core cavities of the product being cast. Arranged to travel immediately behind the vibratory shoes are adapted troweling mandrels that keep the initially formed hollow-core cavity in its desired shape so long as is needed to proceed past the working range of the vibratory effect. The travel of the casting machine is implemented with the help of external drive machinery.

The casting method according to the invention offers the benefit of a single-step casting process that can carried out at a high casting speed. The construction of the casting apparatus according to the invention is uncomplicated and comprises a small number of wearing parts. Furthermore, a single set of auger feeders can be used for casting products of different cross sections.

More specifically, the method according to the invention is characterized by what is stated in the characterizing part of claim 1 and the apparatus according to the invention is characterized by what is stated in the characterizing part of claim 4.

Next, the invention will be examined in greater detail by making reference to the attached drawing, wherein

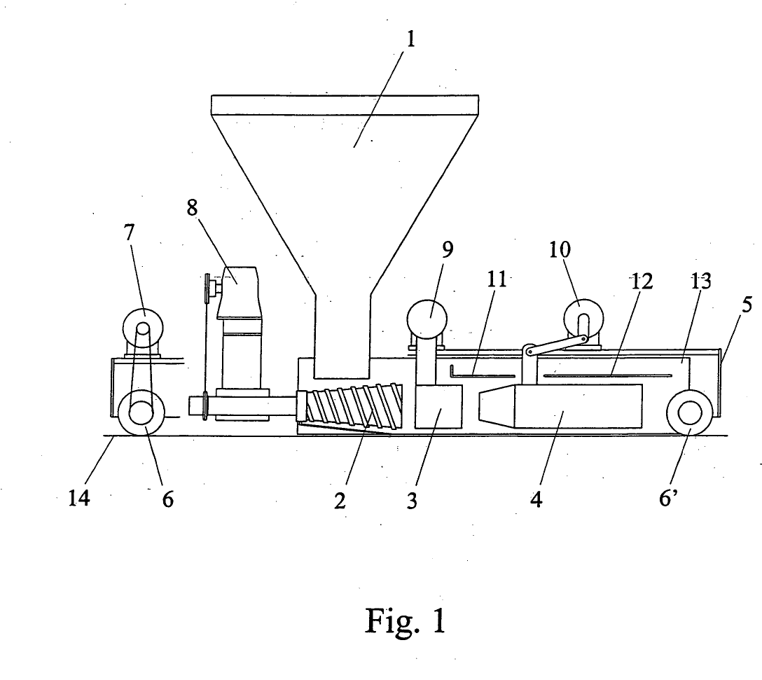

FIG. 1 shows diagrammatically a sectional side elevation view of a slipform casting apparatus according to the invention.

Referring to FIG. 1, the major parts of the slipform apparatus according to the invention shown therein comprise a concrete mix hopper 1, an auger feeder 2, a vibratory shoe 3, a troweling mandrel 4, a frame 5, wheels 6, 6′ and a drive motor 7.

In the operation of the casting apparatus, concrete mix flows from hopper 1 onto auger feeder 2 that extrudes concrete about vibratory shoe 3 over the entire cross section of the closed-wall mold. The vibratory shoe first forms an initial hollow-core cavity in the product being cast and simultaneously compacts the concrete by vibration. The auger feeder is rotated by a drive motor 8 and the vibratory shoe is actuated by vibrator drive machinery 9. Behind the vibratory shoe travels a troweling mandrel 4 that performs a reciprocating movement actuated by drive machinery 10 of the troweling mandrel. The troweling mandrel keeps the initially formed hollow-core cavity in its desired shape so long as is needed to proceed past the working range of the vibratory effect. The slipform casting mold moving along with the casting machine comprises side walls 13 and, acting as the top wall, a vibratory beam 11 and a troweling beam 12. The vibratory beam compacts the cast concrete at the top surface of the product, while the troweling beam smooths the top surface. Either one of these elements is driven by their own drive machinery that are not shown in the FIGURE.

During casting, the apparatus supported on wheels 6, 6′ moves along a casting bed 14 powered by a drive motor 7. The ready-cast product remains resting on the casting bed.

The above operational description of the casting apparatus relates to the formation of a single hollow-core cavity only. Obviously, the invention is not limited as to the number of hollow-core cavities in the product inasmuch as the method according to the invention allows a desired number of cavities to be made in hollow-core slabs to be cast simply by installing a required number of auger feeders, vibratory shoes and troweling mandrels in the casting apparatus.

The method and apparatus according to the invention is capable of casting hollow-core beams in a single-step process employing a casting machine of an uncomplicated structure at a higher casting speed than what has been possible when using a conventional extruder or slipform casting machine.

Furthermore, the casting apparatus according to the invention has few wearing parts as compared to, e.g., an extruder-type casting machine thus making the use of the novel casting apparatus more cost-effective due to the lower spare part costs. Simultaneously, also production halts due to wearing part replacements are shortened substantially.

The apparatus according to the invention can be employed for casting products of different cross sections without the need for changing the auger feeders. As a result, a change of the product cross section can be simply implemented by changing the vibratory shoes and troweling mandrels thus achieving a shorter production halt due to the changes.

1. A method for fabricating a hollow-core concrete product in a continuous slipform casting process, in which method the concrete mix is fed into the entire cross section of a slipforming mold of a defined cross section delimited by the feed means (2) of a slipform casting apparatus in a single-step so as to achieve a concrete product of a desired shape, wherein said feed means (2) propels the concrete mix about vibratory shoes (3) so as to attain a compaction effect.

2. The method of claim 1, wherein subsequent to the concrete mix compaction effected by said vibratory shoes (3), troweling mandrels (4) are employed to keep the initially formed hollow-core cavity in its desired shape so long as is necessary to travel past the effective zone of compacting vibration.

3. The method of claim 1, wherein the travel of said slipform casting apparatus is effected by the propulsive force exerted by said feed means (2) and drive machinery (7).

4. An apparatus for fabricating a hollow-core concrete product in a continuous slipform casting process, the apparatus comprising at least one auger feeder (2) for feeding concrete mix into the entire cross section of a slipforming mold of a defined cross section in a single-step and means (8) for actuating the rotation of said auger feeder, wherein said apparatus includes at least one vibratory shoe (3) for concrete mix compaction and means (9) for effecting the movement of said vibratory shoe.

5. The apparatus of claim 4, wherein the apparatus includes at least one troweling mandrel (4) for keeping the shape of an initially formed hollow-core cavity and means (10) for effecting the movement of said troweling mandrel.

6. The apparatus of claim 4, wherein the apparatus includes drive machinery (7) for aiding the travel of the casting apparatus.

7. The method of claim 2, wherein the travel of said slipform casting apparatus is effected by the propulsive force exerted by said feed means (2) and drive machinery (7).

8. The apparatus of claim 5, wherein the apparatus includes drive machinery (7) for aiding the travel of the casting apparatus.
